(19) United States
(12) Patent Application Publication
(10) Pub. No.: US 2020/0250104 A1
(43) Pub. Date: Aug. 6, 2020

(54) APPARATUS AND METHOD FOR TRANSMITTING MAP INFORMATION IN A MEMORY SYSTEM

(71) Applicant: SK hynix Inc., Icheon-si (KR)

(72) Inventor: Eu-Joon BYUN, Yongin-si (KR)

(73) Assignee: SK hynix Inc., Icheon-si (KR)

(21) Appl. No.: 16/659,179

(22) Filed: Oct. 21, 2019

(30) Foreign Application Priority Data
Jan. 31, 2019 (KR) 10-2019-0012542

(51) Int. Cl. G06F 12/10; G06F 9/4401

(52) U.S. Cl. CPC G06F 12/10; G06F 2212/657; G06F 9/4403

(57) ABSTRACT

A memory system includes a memory device including nonvolatile memory cells and a controller configured to generate map information used for translating a logical address inputted from a host into a physical address indicating a location of data stored in the memory device. The controller is configured to transmit at least some of the map information to the host, store a log regarding the at least some of the map information transmitted to the host, and again transmit the at least some of the map information to the host based on the log during an initial operation.

### CROSS-REFERENCE TO RELATED APPLICATIONS

This patent application claims priority under 35 U.S.C. § 119(a) to Korean Patent Application No. 10-2019-0012542, filed on Jan. 31, 2019, the entire disclosure of which is incorporated herein by reference.

### TECHNICAL FIELD

Various embodiments relate to a memory system, and more particularly, to a method and an apparatus for transmitting map information to a host or a computing device.

### BACKGROUND

Recently, a paradigm for a computing environment has shifted to ubiquitous computing, which enables computer systems to be accessed virtually anytime and everywhere. As a result, the use of portable electronic devices, such as mobile phones, digital cameras, notebook computers, and the like, are rapidly increasing. Such portable electronic devices typically use or include a memory system that uses or embeds at least one memory device, i.e., a data storage device. The data storage device can be used as a main storage device or an auxiliary storage device of a portable electronic device.

Unlike a hard disk, a data storage device using a nonvolatile semiconductor memory device is advantageous in that it has excellent stability and durability because it has no mechanical driving parts (e.g., a mechanical arm), and has high data access speed and low power consumption. In the context of a memory system having such advantages, an exemplary data storage device includes a USB (Universal Serial Bus) memory device, a memory card having various interfaces, a solid state drive (SSD), or the like.

### BRIEF DESCRIPTION OF THE DRAWINGS

The description herein makes reference to the accompanying drawings wherein like reference numerals refer to like parts throughout the figures, and wherein:

FIG. 1 illustrates a method for sharing map information between a host and a memory system in a data processing system in accordance with an embodiment of the present disclosure;

FIG. 2 shows a data processing system including a memory system in accordance with an embodiment of the present disclosure;

FIG. 3 illustrates a memory system in accordance with an embodiment of the present disclosure;

FIG. 4 illustrates configuration of a host and a memory system in a data processing system according to an embodiment of the present disclosure;

FIG. 5 illustrates a read operation of a host and a memory system in a data processing system according to an embodiment of the present disclosure;

FIG. 6 illustrates a first example of a transaction between a host and a memory system in a data processing system according to an embodiment of the present disclosure;

FIG. 7 illustrates a first operation of a host and a memory system according to an embodiment of the present disclosure;

FIG. 8 illustrates an initial operation of a memory system according to an embodiment of the present disclosure;

FIG. 9 illustrates a second example of a transaction between a host and a memory system in a data processing system according to an embodiment of the present disclosure;

FIG. 10 illustrates a second operation of a host and a memory system according to an embodiment of the present disclosure;

FIG. 11 illustrates a third operation of a host and a memory system according to an embodiment of the present disclosure; and

FIG. 12 illustrates a fourth operation of a host and a memory system according to an embodiment of the present disclosure.

### DETAILED DESCRIPTION

Various embodiments of the present disclosure are described below in with reference to the accompanying drawings. Elements and features of the present disclosure, however, may be configured or arranged differently to form other embodiments, which may be variations of any of the disclosed embodiments. Thus, the present teachings are not limited to the embodiments set forth herein. Rather, the described embodiments are provided so that this disclosure is thorough and complete and fully conveys the scope of the present disclosure to those skilled in the art to which the present teachings pertain. It is noted that reference to “an embodiment,” “another embodiment” or the like does not necessarily mean only one embodiment, and different references to any such phrase are not necessarily to the same embodiment(s).

It will be understood that, although the terms “first,” “second,” “third,” and so on may be used herein to identify various elements, these elements are not limited by these terms. These terms are used to distinguish one element from another element that otherwise have the same or similar names. Thus, a first element in one instance could also be termed a second or third element in another instance without departing from the spirit and scope of the present teachings.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or electrically connected or coupled to the latter via an intervening element therebetween. In addition, it will also be understood that when an element is referred to as being “between” two elements, it may be the only element between the two elements, or one or more intervening elements may also be present.

The terminology used herein is for the purpose of describing particular embodiments only and is not intended to be limiting. As used herein, singular forms are intended to include the plural forms and vice versa, unless the context clearly indicates otherwise. The articles ‘a’ and ‘an’ as used in this application and the appended claims should generally be construed to mean ‘one or more’ unless specified otherwise or clear from context to be directed to a singular form.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art. It will be further understood that terms, such as those defined in commonly used dictionaries, should be interpreted as having a meaning that is consistent with their meaning in the context of the present disclosure and the relevant art, and not be interpreted in an idealized or overly formal sense unless expressly so defined herein.

In the following description, numerous specific details are set forth in order to provide a thorough understanding of the present disclosure. The teachings disclosed herein may be practiced without some or all of these specific details. In other instances, well-known process structures and/or processes have not been described in detail in order not to unnecessarily obscure the teachings disclosed herein.

It is also noted, that in some instances, as would be apparent to those skilled in the relevant art, a feature or element described in connection with one embodiment may be used singly or in combination with other features or elements of another embodiment, unless otherwise specifically indicated.

Embodiments of the present disclosure can provide a data process system and a method for operating the data processing system, which includes components and resources such as a memory system and a host and is capable of dynamically allocating plural data paths used for data communication between the components based on usages of the components and the resources.

In addition, embodiments of the present disclosure can provide a method and an apparatus for improving or enhancing operations or performance of a memory system. When a power is resumed after not supplied into a memory system and a host (or a computing device) of the data processing system, the memory system can transmit map information to the host (or the computing device) based on a record, log, and/or history. As used herein, the word “log” extends to include the record and/or history indicated above. The host (or the computing device) can transmit a command to the memory system based on the map information. Because of information inputted along with the command transmitted from the host to the memory system, the memory system can reduce a time spent on address translation.

In addition, embodiments of the present disclosure can provide a method or an apparatus which enables a host or a computing device to transmit a command including a physical location of data to be read within a memory system, even after power is supplied or resumed in a data processing system including the host (or the computing device) and the memory system. The method or the apparatus transferring map information based on a record, log or history can satisfy a user's request more quickly.

In an embodiment, a memory system can include a memory device including nonvolatile memory cells; and a controller configured to generate map information used for translating a logical address inputted from a host into a physical address indicating a location of data stored in the memory device. The controller can be configured to transmit at least some of the map information to the host, store a log or a history regarding the at least some of the map information, and transmit the at least some of the map information to the host based on the log or the history during an initial operation.

By the way of example but not limitation, the controller can be configured to transmit the at least some of the map information in response to host's request.

The controller can be configured to send an inquiry for transmitting the at least some of the map information to the host, and to transmit the at least some of the map information based on host's determination regarding the inquiry.

The controller can be configured to perform an operation corresponding to a command inputted from the host, insert the at least some of the map information into a response regarding the command and transfer the response including the at least some of the map information.

The controller can be configured to: check whether a command inputted from the host includes a logical address and a physical address; determine whether the physical address inputted with the command is valid; determine whether the physical address is used based on a validity of the physical address; and perform an operation corresponding to the command according to a usage of the physical address.

The controller can be configured to ignore the physical address when the physical address is not valid, and to search a valid physical address corresponding to the logical address from the map information stored in the memory device before performing the command.

The controller can be configured to determine an amount of the map information which is included in the log or the history, in response to a size of the map information capable of being transmitted to the host.

In the initial operation, the controller can be configured to execute a firmware, load boot image, abandon and handle over a control authority to the host, and transfer the at least some of the map information after handling over the control authority.

The log or the history can be stored before power-off, and the initial operation can be performed directly after power-on or power is resumed.

In an embodiment, a method for operating a memory system can include generating map information used for translating a logical address inputted from a host into a physical address indicating a location of data stored in the memory device; transferring at least some of the map information to the host; storing a log or a history regarding the at least some of the map information; and transmitting the at least some of the map information to the host based on the log or the history during an initial operation.

The method can further include receiving host's command regarding the at least some of the map information before transmitting the at least some of the map information.

The method can further include sending an inquiry for transmitting the at least some of the map information to the host. The at least some of the map information can be transmitted based on host's determination regarding the inquiry.

The method can further include performing an operation corresponding to a command inputted from the host; and inserting the at least some of the map information into a response regarding the command. The at least some of the map information can be transmitted through the response.

The method can further include checking whether a command inputted from the host includes a logical address and a physical address; determining whether the physical address inputted with the command is valid; determining a usage of the physical address based on a validity of the physical address; and perform an operation corresponding to the command according to the usage of the physical address.

The method can further include ignoring the physical address when the physical address is not valid; and searching a valid physical address corresponding to the logical address from the map information stored in the memory device before performing the command.

The method can further include determining an amount of the map information which is included in the log or the history, in response to a size of the map information capable of being transmitted to the host.

The method can further include, in the initial operation, executing a firmware; loading boot image; and abandoning and handling over a control authority to the host. The at least some of the map information can be transferred after the control authority is handled over.

In an embodiment, a data processing system can include a host configured to generate, change or update a logical address corresponding to data; and a memory system configured to store the data at a location identified through a physical address which is distinguishable from the logical address. The memory system can be configured to transmit at least some of map information used for translating the logical address into the physical address, store a log or a history regarding the at least some of the map information, and transmit the at least some of the map information to the host based on the log or the history during an initial operation.

The memory system is configured to: check whether a command inputted from the host includes a logical address and a physical address; determine whether the physical address inputted with the command is valid; determine whether the physical address is used based on a validity of the physical address; and perform an operation corresponding to the command according to a usage of the physical address.

The memory system can be configured to determine an amount of the map information which is included in the log or the history, in response to a size of the map information capable of being transmitted to the host.

Embodiments of the present disclosure are described with reference to the accompanying drawings, wherein like numbers reference like elements.

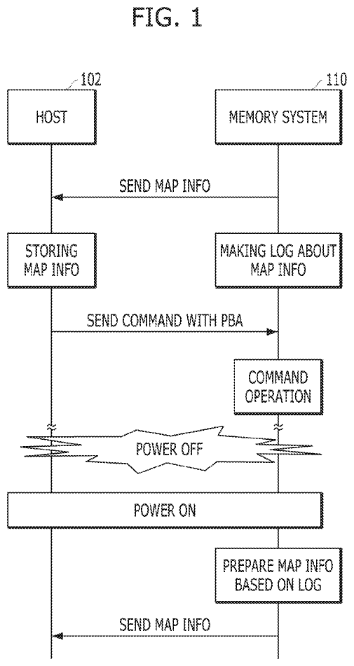

Referring to FIG. 1, it is described how to share map information between a host and a memory system in a data processing system in accordance with an embodiment of the present disclosure.

Referring to FIG. 1, a host 102 and a memory system 110 may be engaged operatively. The host 102 may include a computing device and may be implemented in a form of a mobile device, a computer, a server, or the like. The memory system 110 operatively engaged with the host 102 may receive a command from the host 102 and store or output data in response to the received command.

The memory system 110 may have a storage space including nonvolatile memory cells. For example, the memory system 110 may be implemented in a form of a flash memory, a solid-state drive (SSD), or the like.

In order to store data in response to a request by the host 102 in a storage space including the nonvolatile memory cells, the memory system 110 can perform a mapping operation for associating a file system used by the host 102 with a storage space including the nonvolatile memory cells. This can be referred as to an address translation between a logical address and a physical address. For example, an address identifying data according to the file system used by the host 102 may be called a logical address or a logical block address, and the address indicating a physical location of data in the storage space including nonvolatile memory cells may be referred to as a physical address or a physical block address. When the host 102 sends a read command with a logical address to the memory system 110, the memory system 110 can search for a physical address corresponding to the logical address and then read and output data stored in a physical location indicated by the physical address. During these processes, the mapping operation or the address translation may be performed while the memory system 110 searches for the physical address corresponding to the logical address inputted from the host 102. The mapping operation or the address translation can be performed based on mapping information such as a mapping table which can associate a logical address with a physical address.

If the host 102 can perform the mapping operation performed by the memory system 110, an amount of time taken for the memory system 110 to read and output data corresponding to a read command transmitted by the host 102 may be reduced. The host 102 may store and access at least some of map information for performing the mapping operation, in order to deliver the read command with the physical address into the memory system 110 through the mapping operation.

Referring to FIG. 1, the memory system 110 may transmit map information MAP_INFO to the host 102. The host 102 receiving the map information MAP_INFO delivered from the memory system 110 may store the map information MAP_INFO in a memory included in the host 102. When the memory system 110 sends the entire map information to the host 102 and the host 102 can store the entire map information in the memory, the memory system 110 may not need to write a log regarding transmitted map information. However, it may be difficult for the host 102 to allocate a storage space in memory for storing the entire map information generated and delivered by the memory system 110. Accordingly, when the host has limited storage space for storing map information, the memory system 110 may select or choose a part of map information regarding data or a logical address frequently used or accessed by the host 102 and transmit selected or chosen map information to the host 102.

Meanwhile, the memory system 110 transmitting at least some of the map information to the host 102 may generate a log or a history regarding the transmitted map information. The log or a history may have one of various formats, structures, marks, variables or types, and may be stored in a memory device or a storage area including nonvolatile memory cells. According to an embodiment, whenever the memory system 110 transmits map information to the host 102, the log or the history may include a kind of data which is relevant to transmitted map information. Further, the memory system 110 may determine an amount of transmitted map information recorded in the log or the history corresponding to a size of map information that can be transmitted to the host 102. For example, it may be assumed that a size of map information that the memory system 110 can transmit to the host 102 is 512 KB. Although the memory system 110 may transmit more than 512 KB of map information to the host 102 in a log or a history, the amount of transmitted map information recorded in the log or the history may be limited to 512 KB. The amount of map information that memory system 110 can send to host 102 at one time may be less than the amount of map information that host 102 may store in the memory. For example, the map information may be transmitted to the host 102 in a segment unit. The memory system 110 may transfer segments of the map information to the host 102 several times, and the segments of the map information may be transmitted to the host 102 continuously or intermittently.

According to an embodiment, when the memory system 110 transmits more than 1 MB of map information to the host 102, the host 102 can delete old map information, i.e., previously transmitted from the memory system 110 and stored in a memory, according to a timeline. In addition, the map information transmitted from the memory system 110 to the host 102 may include update information.

Because a space allocated by the host 102 to store the map information transmitted from the memory system 110 includes volatile memory cells (an overwrite is supported), the host 102 can update map information based on the update information without an additional operation of erasing another map information.

The host 102 may add a physical address PBA into a command transmitted to the memory system 110 based on the map information. In the mapping operation, the host 102 can search for and find the physical address PBA in the map information stored in the memory, based on a logical address corresponding to a command transmitted into the memory system 110. When the physical address exists and is found, the host 102 may transmit the command with the logical address and the physical address into the memory system 110.

The memory system 110, which receives a command with a logical address and a physical address inputted from the host 102, may perform a command operation corresponding to the command. As described above, when the host 102 transfers a physical address corresponding to a read command, the memory system 110 can use the physical address to access and output data stored in a location indicated by the physical address using the corresponding physical address. The memory system 110 can perform an operation in response to the read command without address translation, so that the memory system 110 can reduce a time spent on the operation.

When power is not supplied to the host 102 and the memory system 110, all map information stored in the memory including volatile memory cells in the host 102 is lost or disappeared. Power-off or power-on at the host 102 and the memory system 110 may occur according to user's request, or even in an undesired situation regardless user's request. While power is supplied to the host 102 and the memory system 110, the memory system 110 can record a log or a history regarding map information transmitted to the host 102. Thereafter, when power is resumed after power-off, the memory system 110 can transmit map information to the host 102 based on the log or the history so that the host 102 can perform a mapping operation and transmit a command with a logical address and a physical address into the memory system 110. After power is resumed, the host 102 can quickly recover an operation state regarding the mapping operation, which is substantially same to that before the power supply is stopped or not supplied.

Before power is stopped and after power is resumed, needs and usage patterns of users who use a data processing system including the host 102 and the memory system 110 may be similar or different. When a user's needs and usage patterns are not changed, the host 102 may have tried to access or read the same data at a high frequency. When the host 102 performs a mapping operation regarding such data and the memory system 110 can output data more quickly in response to a read command inputted with a logical address and a physical address, it is likely that a user can satisfy performance of the data processing system including the host 102 and the memory system 110.

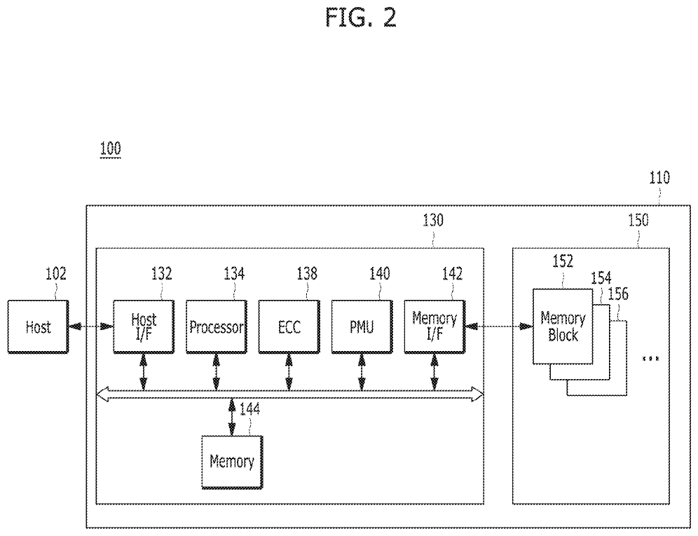

Referring to FIG. 2, a data processing system 100 in accordance with an embodiment of the present disclosure is described. Referring to FIG. 2, the data processing system 100 may include a host 102 engaged or operating with a memory system 110.

The host 102 may include, for example, a portable electronic device such as a mobile phone, an MP3 player and a laptop computer, or an electronic device such as a desktop computer, a game player, a television (TV), a projector, and the like.

The host 102 also includes at least one operating system (OS), which can generally manage, and control, functions and operations performed in the host 102. The OS can provide interoperability between the host 102 engaged with the memory system 110 and the user needing and using the memory system 110. The OS may support functions and operations corresponding to a user's requests. By the way of example but not limitation, the OS can be classified into a general operating system and a mobile operating system according to mobility of the host 102. The general operating system may be split into a personal operating system and an enterprise operating system according to system requirements or a user's environment. The personal operating system, including Windows and Chrome, may be subject to support services for general purposes. But the enterprise operating systems can be specialized for securing and supporting high performance, including Windows servers, Linux, Unix, and the like. Further, the mobile operating system may include Android, iOS, Windows mobile, and the like. The mobile operating system may be subject to support services or functions for mobility (e.g., a power saving function). The host 102 may include a plurality of operating systems. The host 102 may execute multiple operating systems interlocked with the memory system 110, corresponding to a user's request. The host 102 may transmit a plurality of commands corresponding to the user's requests into the memory system 110, thereby performing operations corresponding to commands within the memory system 110.

The memory system 110 may operate or perform a specific function or operation in response to a request from the host 102 and, particularly, may store data to be accessed by the host 102. The memory system 110 may be used as a main memory system or an auxiliary memory system of the host 102. The memory system 110 may be implemented with any one of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, a memory stick, and the like.

The storage devices for the memory system 110 may be implemented with a volatile memory device, for example, a dynamic random access memory (DRAM) and a static RAM (SRAM), and/or a nonvolatile memory device such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM or ReRAM), and a flash memory.

The memory system 110 may include a controller 130 and a memory device 150. The memory device 150 may store data to be accessed by the host 102. The controller 130 may control storage of data in the memory device 150.

The controller 130 and the memory device 150 may be integrated into a single semiconductor device, which may be included in any of the various types of memory systems as discussed above in the examples.

By the way of example but not limitation, the controller 130 and the memory device 150 may be integrated into a single semiconductor device. The controller 130 and memory device 150 may be integrated into an SSD for improving an operation speed. When the memory system 110 is used as an SSD, the operating speed of the host 102 connected to the memory system 110 can be improved more than that of the host 102 implemented with a hard disk. In addition, the controller 130 and the memory device 150 may be integrated into one semiconductor device to form a memory card, such as a PC card (PCMCIA), a compact flash card (CF), a memory card such as a smart media card (SM, SMC), a memory stick, a multimedia card (MMC, RS-MMC, MMCmicro), a SD card (SD, miniSD, microSD, SDHC), a universal flash memory, or the like.

The memory system 110 may be configured as a part of, for example, a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various components configuring a computing system.

The memory device 150 may be a nonvolatile memory device and may retain data stored therein even while an electrical power is not supplied. The memory device 150 may store data provided from the host 102 through a write operation, while providing data stored therein to the host 102 through a read operation. The memory device 150 may include a plurality of memory blocks 152, 154, 156, each of which may include a plurality of pages. Each of the plurality of pages may include a plurality of memory cells to which a plurality of word lines (WL) are electrically coupled. The memory device 150 also includes a plurality of memory dies, each of which includes a plurality of planes, each of which includes a plurality of memory blocks 152, 154, 156. In addition, the memory device 150 may be a non-volatile memory device, for example a flash memory, wherein the flash memory may be embodied in a three-dimensional stack structure.

The controller 130 may control overall operations of the memory device 150, such as read, write, program, and erase operations. For example, the controller 130 may control the memory device 150 in response to a request from the host 102. The controller 130 may provide data, read from the memory device 150, to the host 102. The controller 130 may also store data, provided by the host 102, into the memory device 150.

The controller 130 may include a host interface (I/F) 132, a processor 134, an error correction code (ECC) component 138, a power management unit (PMU) 140, a memory interface (I/F) 142, and memory 144, all operatively coupled via an internal bus.

The host interface 132 may process commands and data provided by the host 102, and may communicate with the host 102 through at least one of various interface protocols such as universal serial bus (USB), multimedia card (MMC), peripheral component interconnect-express (PCI-e or PCIe), small computer system interface (SCSI), serial-attached SCSI (SAS), serial advanced technology attachment (SATA), parallel advanced technology attachment (PATA), small computer system interface (SCSI), enhanced small disk interface (ESDI), and integrated drive electronics (IDE). In accordance with an embodiment, the host interface 132 is a component for exchanging data with the host 102, which may be implemented through firmware called a host interface layer (HIL).

The ECC component 138 can correct error bits of the data to be processed in (e.g., outputted from) the memory device 150, which may include an ECC encoder and an ECC decoder. Here, the ECC encoder can perform error correction encoding of data to be programmed in the memory device 150 to generate encoded data into which a parity bit is added and store the encoded data in memory device 150. The ECC decoder can detect and correct errors contained in a data read from the memory device 150 when the controller 130 reads the data stored in the memory device 150. In other words, after performing error correction decoding on the data read from the memory device 150, the ECC component 138 can determine whether the error correction decoding has succeeded and output an instruction signal (e.g., a correction success signal or a correction fail signal). The ECC component 138 can use the parity bit which is generated during the ECC encoding process, for correcting the error bit of the read data. When the number of the error bits is greater than or equal to a threshold number of correctable error bits, the ECC component 138 might not correct error bits but instead may output an error correction fail signal indicating failure in correcting the error bits.

The ECC component 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a.

Block coded modulation (BCM), and so on. The ECC component 138 may include and all circuits, modules, systems or devices for performing the error correction operation based on at least one of the above described codes.

The PMU 140 may manage electrical power provided in the controller 130.

The memory interface 142 may serve as an interface for handling commands and data transferred between the controller 130 and the memory device 150, to allow the controller 130 to control the memory device 150 in response to a request delivered from the host 102. The memory interface 142 may generate a control signal for the memory device 150 and may process data entered into or outputted from the memory device 150 under the control of the processor 134 in a case when the memory device 150 is a flash memory and, in particular, when the memory device 150 is a NAND flash memory. The memory interface 142 can provide an interface for handling commands and data between the controller 130 and the memory device 150, for example, operations of NAND flash interface, in particular, operations between the controller 130 and the memory device 150. In accordance with an embodiment, the memory interface 142 can be implemented through firmware called a Flash Interface Layer (FIL) as a component for exchanging data with the memory device 150.

The memory 144 may support operations performed by the memory system 110 and the controller 130. The memory 144 may store temporary or transactional data occurred or delivered for operations in the memory system 110 and the controller 130. The controller 130 may control the memory device 150 in response to a request from the host 102. The controller 130 may deliver data read from the memory device 150 into the host 102. The controller 130 may store data entered through the host 102 within the memory device 150. The memory 144 may be used to store data for the controller 130 and the memory device 150 to perform operations such as read operations or program/write operations.

The memory 144 may be implemented as a volatile memory. The memory 144 may be implemented with a static random access memory (SRAM), a dynamic random access memory (DRAM), or both. Although FIG. 2 illustrates, for example, the second memory 144 disposed within the controller 130, embodiments are not limited thereto. That is, the memory 144 may be located within or external to the controller 130. For instance, the memory 144 may be embodied by an external volatile memory having a memory interface transferring data and/or signals between the memory 144 and the controller 130.

The memory 144 can store data necessary for performing operations such as data writing and data reading requested by the host 102 and/or data transfer between the memory device 150 and the controller 130 for background operations such as garbage collection and wear levelling as described above. In accordance with an embodiment, for supporting operations in the memory system 110, the memory 144 may include a program memory, a data memory, a write buffer/cache, a read buffer/cache, a data buffer/cache, a map buffer/cache, and the like.

The processor 134 may be implemented with a microprocessor or a central processing unit (CPU). The memory system 110 may include one or more processors 134. The processor 134 may control the overall operations of the memory system 110. By way of example but not limitation, the processor 134 can control a program operation or a read operation of the memory device 150, in response to a write request or a read request entered from the host 102. In accordance with an embodiment, the processor 134 may use or execute firmware to control the overall operations of the memory system 110. Herein, the firmware may be referred to as a flash translation layer (FTL). The FTL may perform an operation as an interface between the host 102 and the memory device 150. The host 102 may transmit requests for write and read operations to the memory device 150 through the FTL.

The FTL may manage operations of address mapping, garbage collection, wear-leveling, and the like. Particularly, the FTL may load, generate, update, or store map data. Therefore, the controller 130 may map a logical address, which is entered from the host 102, with a physical address of the memory device 150 through the map data.

The memory device 150 may look like a general storage device to perform a read or write operation because of the address mapping operation. Also, through the address mapping operation based on the map data, when the controller 130 tries to update data stored in a particular page, the controller 130 may program the updated data on another empty page and may invalidate old data of the particular page (e.g., update a physical address, corresponding to a logical address of the updated data, from the previous particular page to the another newly programed page) due to a characteristic of a flash memory device. Further, the controller 130 may store map data of the new data into the FTL.

For example, when performing an operation requested from the host 102 in the memory device 150, the controller 130 uses the processor 134 implemented in a microprocessor or central processing unit (CPU) or the like. The processor 134 engaged with the memory device 150 can handle instructions or commands corresponding to an inputted command from the host 102. The controller 130 can perform a foreground operation as a command operation, corresponding to an command inputted from the host 102, such as a program operation corresponding to a write command, a read operation corresponding to a read command, an erase/discard operation corresponding to an erase/discard command and a parameter set operation corresponding to a set parameter command or a set feature command with a set command.

For another example, the controller 130 may perform a background operation on the memory device 150 through the processor 134. By way of example but not limitation, the background operation for the memory device 150 includes an operation of copying and storing data stored in a memory block among the memory blocks 152, 154, 156 in the memory device 150 to another memory block, e.g., a garbage collection (GC) operation. The background operation can include an operation of moving or swapping data stored in at least one of the memory blocks 152, 154, 156 into at least another of the memory blocks 152, 154, 156, e.g., a wear leveling (WL) operation.

During a background operation, the controller 130 may use the processor 134 for storing the map data stored in the controller 130 to at least one of the memory blocks 152, 154, 156 in the memory device 150, e.g., a map flush operation. A bad block management operation of checking or searching for bad blocks among the memory blocks 152, 154, 156 is another example of a background operation performed by the processor 134.

In the memory system 110, the controller 130 performs a plurality of command operations corresponding to a plurality of commands entered from the host 102. For example, when performing a plurality of program operations corresponding to a plurality of program commands, a plurality of read operations corresponding to a plurality of read commands, and a plurality of erase operations corresponding to a plurality of erase commands sequentially, randomly, or alternatively, the controller 130 can determine which channel(s) or way(s) among a plurality of channels (or ways) for connecting the controller 130 to a plurality of memory dies included in the memory 150 is/are proper or appropriate for performing each operation. The controller 130 can send or transmit data or instructions via determined channels or ways for performing each operation. The plurality of memory dies included in the memory 150 can transmit an operation result via the same channels or ways, respectively, after each operation is complete. Then, the controller 130 may transmit a response or an acknowledge signal to the host 102. In an embodiment, the controller 130 can check a status of each channel or each way. In response to a command entered from the host 102, the controller 130 may select at least one channel or way based on the status of each channel or each way so that instructions and/or operation results with data may be delivered via selected channel(s) or way(s).

By the way of example but not limitation, the controller 130 can recognize statuses regarding a plurality of channels (or ways) associated with a plurality of memory dies included in the memory device 150. The controller 130 may determine the state of each channel or each way as one of a busy state, a ready state, an active state, an idle state, a normal state, and/or an abnormal state. The controller's determination of which channel or way an instruction (and/or a data) is delivered through can be associated with a physical block address, e.g., which die(s) the instruction (and/or the data) is delivered into. The controller 130 can refer to descriptors delivered from the memory device 150. The descriptors can include a block or page of parameters that describe something about the memory device 150, which is data with a predetermined format or structure. For instance, the descriptors may include device descriptors, configuration descriptors, unit descriptors, and the like. The controller 130 can refer to, or use, the descriptors to determine which channel(s) or way(s) an instruction or a data is exchanged via.

A management unit (not shown) may be included in the processor 134. The management unit may perform bad block management of the memory device 150. The management unit may find bad memory blocks in the memory device 150, which are in unsatisfactory condition for further use, as well as perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. The bad blocks may seriously aggravate the utilization efficiency of the memory device 150 having a 3D stack structure and the reliability of the memory system 110. Thus, reliable bad block management may enhance or improve performance of the memory system 110.

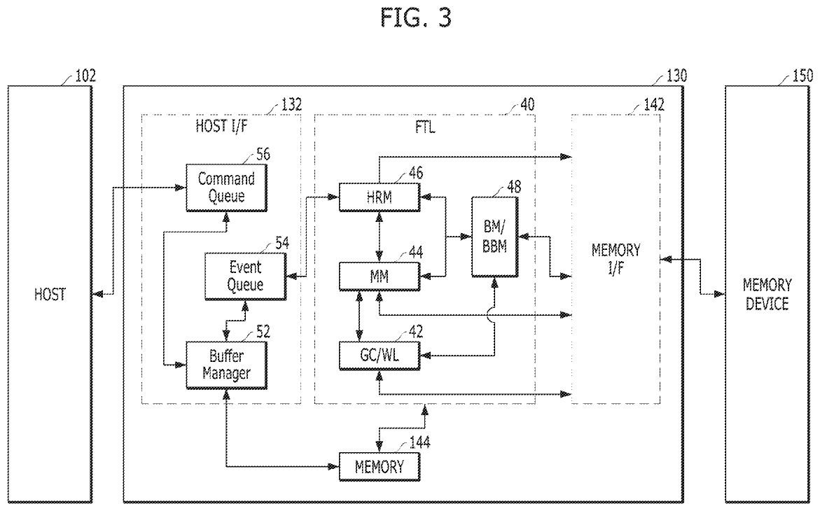

Referring to FIG. 3, a controller in a memory system in accordance with another embodiment of the present disclosure is described. The controller 130 cooperates with the host 102 and the memory device 150. As illustrated, the controller 130 includes a host interface 132, a flash translation layer (FTL) 40, as well as the host interface 132, the memory interface 142, and the memory 144 previously identified in connection with FIG. 2.

Although not shown in FIG. 3, in accordance with an embodiment, the ECC unit 138 described with reference to FIG. 2 may be included in the flash translation layer (FTL) 40. In another embodiment, the ECC unit 138 may be implemented as a separate module, a circuit, firmware, or the like, which is included in, or associated with, the controller 130.

The host interface 132 is for handling commands, data, and the like transmitted from the host 102. By way of example but not limitation, the host interface 132 may include a command queue 56, a buffer manager 52, and an event queue 54. The command queue 56 may sequentially store commands, data, and the like received from the host 102 and output them to the buffer manager 52 in an order in which they are stored. The buffer manager 52 may classify, manage, or adjust the commands, the data, and the like, which are received from the command queue 56. The event queue 54 may sequentially transmit events for processing the commands, the data, and the like received from the buffer manager 52.

A plurality of commands or data of the same characteristic, e.g., read or write commands, may be transmitted from the host 102, or commands and data of different characteristics may be transmitted to the memory system 110 after being mixed or jumbled by the host 102. For example, a plurality of commands for reading data (read commands) may be delivered, or commands for reading data (read command) and programming/writing data (write command) may be alternately transmitted to the memory system 110. The host interface 132 may store commands, data, and the like, which are transmitted from the host 102, to the command queue 56 sequentially. Thereafter, the host interface 132 may estimate or predict what kind of internal operation the controller 130 will perform according to the characteristics of commands, data, and the like, which have been entered from the host 102. The host interface 132 can determine a processing order and a priority of commands, data and the like, based at least on their characteristics. According to characteristics of commands, data, and the like transmitted from the host 102, the buffer manager 52 in the host interface 132 is configured to determine whether the buffer manager should store commands, data, and the like in the memory 144, or whether the buffer manager should deliver the commands, the data, and the like into the flash translation layer (FTL) 40. The event queue 54 receives events, entered from the buffer manager 52, which are to be internally executed and processed by the memory system 110 or the controller 130 in response to the commands, the data, and the like transmitted from the host 102, so as to deliver the events into the flash translation layer (FTL) 40 in the order received.

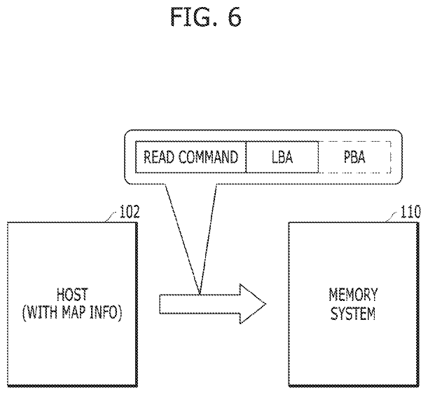

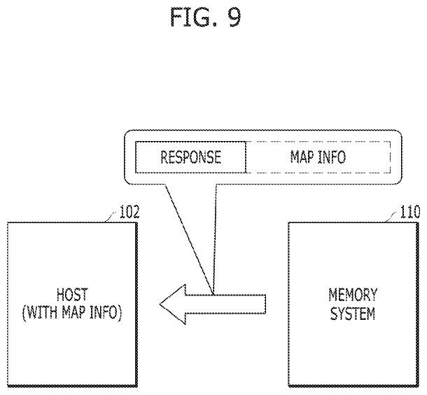

In accordance with an embodiment, the host interface 132 described with reference to FIG. 3 may perform some functions of the controller 130 described with reference to FIGS. 1 and 2. The host interface 132 may set the memory 106 in the host 102, which is shown in FIG. 6 or 9, as a slave and add the memory 106 as an additional storage space which is controllable or usable by the controller 130.

In accordance with an embodiment, the flash translation layer (FTL) 40 can include a host request manager (HRM) 46, a map manager (MM) 44, a state manager 42, and a block manager 48.

The host request manager (HRM) 46 can manage the events entered from the event queue 54. The map manager (MM) 44 can handle or control a map data. The state manager 42 can perform garbage collection (GC) or wear leveling (WL). The block manager 48 can execute commands or instructions onto a block in the memory device 150.

By way of example but not limitation, the host request manager (HRM) 46 can use the map manager (MM) 44 and the block manager 48 to handle or process requests according to the read and program commands, and events which are delivered from the host interface 132. The host request manager (HRM) 46 can send an inquiry request to the map data manager (MM) 44, to determine a physical address corresponding to the logical address which is entered with the events. The host request manager (HRM) 46 can send a read request with the physical address to the memory interface 142, to process the read request (handle the events). On the other hand, the host request manager (HRM) 46 can send a program request (write request) to the block manager 48, to program data to a specific empty page (no data) in the memory device 150, and then, can transmit a map update request corresponding to the program request to the map manager (MM) 44, to update an item relevant to the programmed data in information of mapping the logical-physical addresses to each other.

Here, the block manager 48 can convert a program request delivered from the host request manager (HRM) 46, the map data manager (MM) 44, and/or the state manager 42 into a flash program request used for the memory device 150, to manage flash blocks in the memory device 150. In order to maximize or enhance program or write performance of the memory system 110 (see FIG. 2), the block manager 48 may collect program requests and send flash program requests for multiple-plane and one-shot program operations to the memory interface 142. In an embodiment, the block manager 48 sends several flash program requests to the memory interface 142 to enhance or maximize parallel processing of the multi-channel and multi-directional flash controller.

On the other hand, the block manager 48 can be configured to manage blocks in the memory device 150 according to the number of valid pages, select and erase blocks having no valid pages when a free block is needed, and select a block including the least number of valid pages when it is determined that garbage collection is necessary. The state manager 42 can perform garbage collection to move the valid data to an empty block and erase the blocks containing the moved valid data so that the block manager 48 may have enough free blocks (empty blocks with no data). If the block manager 48 provides information regarding a block to be erased to the state manager 42, the state manager 42 could check all flash pages of the block to be erased to determine whether each page is valid. For example, to determine validity of each page, the state manager 42 can identify a logical address recorded in an out-of-band (0013) area of each page. To determine whether each page is valid, the state manager 42 can compare the physical address of the page with the physical address mapped to the logical address obtained from the inquiry request. The state manager 42 sends a program request to the block manager 48 for each valid page. A mapping table can be updated through the update of the map manager 44 when the program operation is complete.

The map manager 44 can manage a logical-physical mapping table. The map manager 44 can process requests such as queries, updates, and the like, which are generated by the host request manager (HRM) 46 or the state manager 42. The map manager 44 may store the entire mapping table in the memory device 150 (e.g., a flash/non-volatile memory) and cache mapping entries according to the storage capacity of the memory 144. When a map cache miss occurs while processing inquiry or update requests, the map manager 44 may send a read request to the memory interface 142 to load a relevant mapping table stored in the memory device 150. When the number of dirty cache blocks in the map manager 44 exceeds a certain threshold, a program request can be sent to the block manager 48 so that a clean cache block is made and the dirty map table may be stored in the memory device 150.

On the other hand, when garbage collection is performed, the state manager 42 copies valid page(s) into a free block, and the host request manager (HRM) 46 can program the latest version of the data for the same logical address of the page and currently issue an update request. When the status manager 42 requests the map update in a state in which copying of valid page(s) is not completed normally, the map manager 44 might not perform the mapping table update. It is because the map request is issued with old physical information if the status manger 42 requests a map update and a valid page copy is completed later. The map manager 44 may perform a map update operation to ensure accuracy only if the latest map table still points to the old physical address.

In accordance with an embodiment, at least one of the state manager 42, the map manager 44, or the block manager 48 can include circuitry for performing its own operation. As used in the present disclosure, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” also covers an implementation of merely a processor (or multiple processors) or portion of a processor and its (or their) accompanying software and/or firmware. The term “circuitry” also covers, for example, and if applicable to a particular claim element, an integrated circuit for a storage device.

The memory device 150 can include a plurality of memory blocks. The plurality of memory blocks can be any of different types of memory blocks such as single-level cell (SLC) memory blocks, multi-level cell (MLC) memory blocks, or the like, according to the number of bits that can be stored or represented in one memory cell. Here, the SLC memory block includes a plurality of pages implemented by memory cells each storing one bit of data. The SLC memory block can have high data I/O operation performance and high durability. The MLC memory block includes a plurality of pages implemented by memory cells each storing multi-bit data (e.g., two bits or more). The MLC memory block can have larger storage capacity for the same space compared to the SLC memory block. The MLC memory block can be highly integrated in view of storage capacity. In an embodiment, the memory device 150 may be implemented with MLC memory blocks, such as an MLC memory block, a triple-level cell (TLC) memory block, a quadruple-level cell (QLC) memory block, or a combination thereof. The MLC memory block may include a plurality of pages implemented by memory cells, each capable of storing 2-bit data. The triple-level cell (TLC) memory block can include a plurality of pages implemented by memory cells, each capable of storing 3-bit data. The quadruple-level cell (QLC) memory block can include a plurality of pages implemented by memory cells, each capable of storing 4-bit data. In another embodiment, the memory device 150 can be implemented with a block including a plurality of pages implemented by memory cells, each capable of storing five or more bits of data.

In an embodiment of the present disclosure, the memory device 150 is embodied as nonvolatile memory such as a flash memory such as a NAND flash memory, a NOR flash memory, and the like. Alternatively, the memory device 150 may be implemented by at least one of a phase change random access memory (PCRAM), a ferroelectrics random access memory (FRAM), a spin injection magnetic memory (STT-RAM), a spin transfer torque magnetic random access memory (STT-MRAM), or the like.

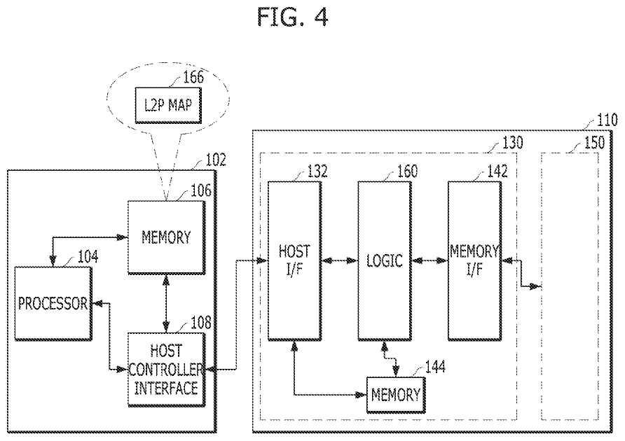

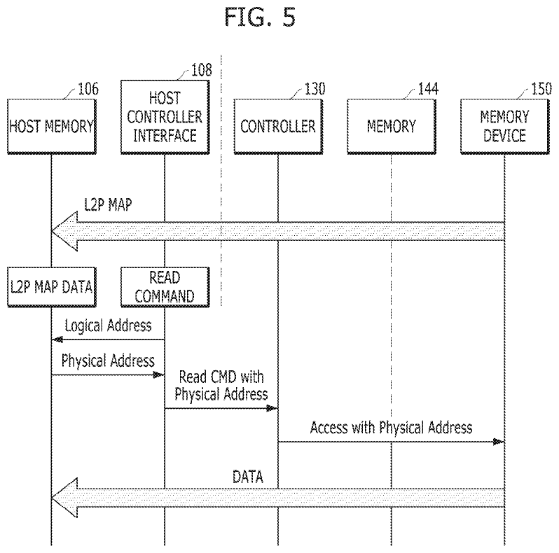

FIGS. 4 and 5 illustrate a case where a part of memory included in a host can be used as a cache device for storing metadata used in the memory system.

Referring to FIG. 4, the host 102 may include a processor 104, memory 106, and a host controller interface 108. The memory system 110 may include a controller 130 and a memory device 150. Herein, the controller 130 and the memory device 150 described with reference to FIG. 4 may correspond to the controller 130 and the memory device 150 described with reference to FIGS. 1 to 3.

Hereinafter, a difference between the controller 130 and the memory device 150 shown in FIG. 4 and the controller 130 and the memory device 150 shown in FIGS. 1 to 3, which can technically be distinguished, is mainly described. Particularly, a logic block 160 in the controller 130 may correspond to the flash translation layer (FTL) 40 described with reference to FIG. 3. However, according to an embodiment, the logic block 160 in the controller 130 may perform an additional function not described in the flash translation layer (FTL) 40 shown in FIG. 3.

The host 102 may include the processor 104, which has a higher performance than that of the memory system 110, and the memory 106 which is capable of storing a larger amount of data than that of the memory system 110 that cooperates with the host 102. The processor 104 and the memory 106 in the host 102 can have an advantage in terms of space and upgradability. For example, the processor 104 and the memory 106 can have less of a space limitation than the processor 134 and the memory 144 in the memory system 110. The processor 104 and the memory 106 can be replaceable for upgrading their performance, which is distinguishable from the processor 134 and the memory 144 in the memory system 110. In the embodiment, the memory system 110 can utilize the resources possessed by the host 102 in order to increase the operation efficiency of the memory system 110.

As an amount of data which can be stored in the memory system 110 increases, an amount of metadata corresponding to the data stored in the memory system 110 also increases. When storage capability used to load the metadata in the memory 144 of the controller 130 is limited or restricted, the increase in an amount of loaded metadata may cause an operational burden on operations of the controller 130. For example, because of limitation of space or region allocated for metadata in the memory 144 of the controller 130, a part, but not all, of the metadata may be loaded. If the loaded metadata does not include specific metadata for a physical location to which the host 102 is intended to access, the controller 130 must store the loaded metadata back into the memory device 150 if some of the loaded metadata has been updated, as well as load the specific metadata for the physical location to which the host 102 is intended to access. These operations should be performed for the controller 130 to perform a read operation or a write operation required by the host 102, and may degrade performance of the memory system 110.

Storage capability of the memory 106 included in the host 102 may be tens or hundreds of times larger than that of the memory 144 included in the controller 130. The memory system 110 may transfer a metadata 166 used by the controller 130 to the memory 106 in the host 102 so that at least some part of the memory 106 in the host 102 may be accessed by the memory system 110. The at least some part of the memory 106 can be used as a cache memory for address translation required for reading or writing data in the memory system 110. In this case, the host 102 translates a logical address into a physical address based on the metadata 166 stored in the memory 106 before transmitting the logical address along with a request, a command, or an instruction to the memory system 110. Then, the host 102 can transmit the translated physical address with the request, the command, or the instruction to the memory system 110. The memory system 110, which receives the translated physical address with the request, the command, or the instruction, may skip an internal process of translating the logical address into the physical address and access the memory device 150 based on the physical address transferred. In this case, an overhead (e.g., operational burden) of the controller 130 loading metadata from the memory device 150 for the address translation may be gone, and operational efficiency of the memory system 110 can be enhanced.

On the other hand, even if the memory system 110 transmits the metadata 166 to the host 102, the memory system 110 can control mapping information based on the metadata 166 such as metadata generation, erase, update, and the like. The controller 130 in the memory system 110 may perform a background operation such as garbage collection and wear leveling according to an operation state of the memory device 150 and may determine a physical address, i.e., which physical location in the memory device 150 data transferred from the host 102 is to be stored. Because a physical address of data stored in the memory device 150 may be changed and the host 102 has not recognized the changed physical address, the memory system 110 may control the metadata 166 initiatively.

While the memory system 110 controls metadata used for the address translation, it can be determined that the memory system 110 needs to modify or update the metadata 166 previously transmitted to the host 102. The memory system 110 can send a signal or metadata to the host 102 so as to request the update of the metadata 166 stored in the host 102. The host 102 may update the stored metadata 166 in the memory 106 in response to a request delivered from the memory system 110. This allows the metadata 166 stored in the memory 106 in the host 102 to be kept as the latest version such that, even though the host controller interface 108 uses the metadata 166 stored in the memory 106, there is no problem in an operation that a logical address is translated into a physical address and the translated physical address is transmitted along with the logical address to the memory system 110.

Meanwhile, the metadata 166 stored in the memory 106 may include mapping information used for translating a logical address into a physical address. Referring to FIG. 4, metadata associating a logical address with a physical address may include two distinguishable items: a first mapping information item used for translating a logical address into a physical address; and a second mapping information item used for translating a physical address into a logical address. Among them, the metadata 166 stored in the memory 106 may include the first mapping information. The second mapping information can be primarily used for internal operations of the memory system 110, but might not be used for operations requested by the host 102 to store data in the memory system 110 or read data corresponding to a particular logical address from the memory system 110. Depending on an embodiment, the second mapping information item might not be transmitted by the memory system 110 to the host 102.

Meanwhile, the controller 130 in the memory system 110 can control (e.g., create, delete, update, etc.) the first mapping information item or the second mapping information item, and store either the first mapping information item or the second mapping information item to the memory device 150. Because the memory 106 in the host 102 is a type of volatile memory, the metadata 166 stored in the memory 106 may disappear when an event such as interruption of power supply to the host 102 and the memory system 110 occurs. Accordingly, the controller 130 in the memory system 110 might not only keep the latest state of the metadata 166 stored in the memory 106 of the host 102, but also store the latest state of the first mapping information item or the second mapping information item in the memory device 150.

Referring to FIGS. 4 and 5, an operation requested by the host 102 to read data stored in the memory system 110 is described when the metadata 166 is stored in the memory 106 of the host 102.

Power is supplied to the host 102 and the memory system 110, and then the host 102 and the memory system 110 can be engaged with each other. When the host 102 and the memory system 110 cooperate, the metadata (L2P MAP) stored in the memory device 150 can be transferred to the host memory 106.

When a read command (Read CMD) is issued by the processor 104 in the host 102, the read command is transmitted to the host controller interface 108. After receiving the read command, the host controller interface 108 searches for a physical address corresponding to a logical address corresponding to the read command in the metadata (L2P MAP) stored in the host memory 106.

Based on the metadata (L2P MAP) stored in the host memory 106, the host controller interface 108 can recognize the physical address corresponding to the logical address. The host controller interface 108 carries out an address translation for the logical address associated with the read command.

The host controller interface 108 transfers the read command (Read CMD) with the logical address as well as the physical address into the controller 130 of the memory system 110. The controller 130 can access the memory device 150 based on the physical address entered with the read command. Data stored at a location corresponding to the physical address in the memory device 150 can be transferred to the host memory 106 in response to the read command (Read CMD).

An operation of reading data stored in the memory device 150 including a nonvolatile memory may take more time than an operation of reading data stored in the host memory 106 or the like which is a volatile memory. In the above-described operation for handling the read command (Read CMD), the controller 130 may skip or omit an address translation corresponding to the logical address entered from the host 102 (e.g., searching for and recognizing a physical address associated with the logical address). For example, in the address translation, the controller 130 might not have to load metadata from the memory device 150 or replace the metadata stored in the memory 144 when the controller 130 cannot find metadata for the address translation in the memory 144. This allows the memory system 110 to perform a read operation requested by the host 102 more quickly.

FIG. 6 illustrates a first example of a transaction between a host 102 and a memory system 110 in a data processing system according to an embodiment of the present disclosure.

Referring to FIG. 6, the host 102 storing the map information (MAP INFO) may transmit a read command including a logical address LBA and a physical address PBA to the memory system 110. When a physical address PBA corresponding to a logical address LBA transmitted with a read command (READ COMMAND) into the memory system 110 is found in the map information stored in the host 102, the host 102 can transmit the read command (READ COMMAND) with the logical address LBA and the physical address PBA into the memory system 110. However, when the physical address PBA corresponding to the logical address LBA transmitted with the read command (READ COMMAND) is not found in the map information stored by the host 102, the host 102 may transmit the read command (READ COMMAND) including only the logical address LBA without the physical address PBA into the memory system 110.

Although FIG. 6 describes an operation in response to the read command (READ COMMAND) as an example, an embodiment of the present disclosure may be applied to a write command or an erase command which the host 102 may transfer into the memory system 110.

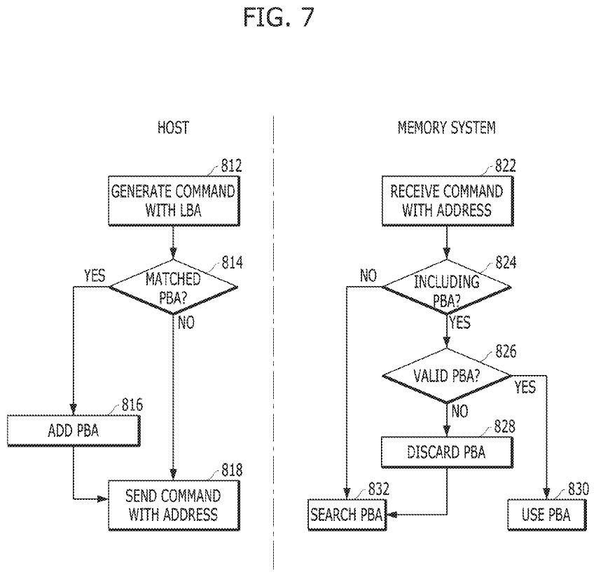

FIG. 7 illustrates a first operation of a host and a memory system according to an embodiment of the present disclosure. In detail, FIG. 7 illustrates detailed operations of the host transmitting a command including a logical address LBA and a physical address.

PBA and the memory system receiving the command with the logical address LBA and the physical address PBA, like the host 102 and the memory system 110 described with reference to FIG. 6.

Referring to FIG. 7, the host may generate a command COMMAND including a logical address LBA (step 812). Thereafter, the host may check whether a physical address PBA corresponding to the logical address LBA is in the map information (step 814). If there is no physical address PBA (NO in step 814), the host may transmit a command COMMAND including the logical address LBA without the physical address PBA (step 818).

On the other hand, if there is the physical address PBA (YES of step 814), the host may add the physical address PBA to the command COMMAND including the logical address LBA (step 816). The host may transmit the command COMMAND including the logical address LBA and the physical address PBA (step 818).

The memory system may receive a command which is externally transmitted (step 822). The memory system may check whether the command is inputted with a physical address PBA (step 824). When the command is not inputted with a physical address PBA (NO in step 824), the memory system may perform a mapping operation or an address translation, e.g., search for a physical address corresponding to the logical address inputted with the command (step 832).

When the command is inputted with the physical address PBA (YES of step 824), the memory system may check whether the physical address PBA is valid (step 826). The memory system has delivered the map information to the host, and the host may perform the mapping operation based on the map information delivered from the memory system so as to transmit the command with the physical address PBA to the memory system. However, after the memory system transmits map information to the host, the transmitted map information managed or controlled by the memory system may be changed and updated. When map information is dirty, the physical address PBA delivered from the host might not be used to access data as it is, so the memory system can determine whether the physical address PBA inputted with the command is valid, i.e., whether map information corresponding to the physical address PBA is changed or updated. When the physical address PBA inputted with the command is valid (YES at step 826), the memory system may perform an operation corresponding to the command using the physical address PBA (step 830).

When the physical address PBA inputted with the command is not valid (NO in step 826), the memory system may ignore the physical address PBA inputted with the command (step 828). In this case, the memory system may search for a physical address PBA based on the logical address LBA inputted with the command (step 832).

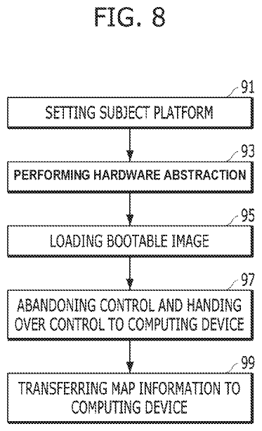

FIG. 8 illustrates an initial operation of the memory system according to an embodiment of the present disclosure. FIG. 8 illustrates that the initial operation may be performed in the memory system 110 when power is supplied to the host 102 and the memory system 110 during the operations described with reference to FIG. 1.

For example, the initial operation can include a boot-up sequence or an operation which may be performed before a host requests user data from the memory system after power is supplied. An operation of the memory system shown in FIG. 8 may vary depending on whether the memory system is mounted on a mobile device, a notebook computer, or a computing device such as a desktop.

Referring to FIG. 8, the operation of the memory system via firmware includes setting a subject platform (step 91), performing hardware abstraction (step 93), loading a bootable image (step 95), abandoning control and handing over control to a computing device which is associated or engaged with the memory device (step 97), and transferring map information to the computing device (step 99). Herein, the computing device may include the host 102 shown in FIGS. 1 to 7.

The setting step 91 of the subject platform may be performed by preparing an environment for booting an operating system (OS), thereby confirming whether the subject platform has been initialized. In this step, exact core type and platform should be found and recognized because the same executable image can be performed on different cores or platforms. By way of example but not limitation, the type of core may be stored in the 0th register of a co-processor. The type of platform may be determined by checking whether a specific peripheral device exists or reading information stored in the chip.

In addition, in accordance with an embodiment, in step 91 of setting the subject platform, diagnostic software may be used to determine whether a hardware component is defective.

In addition, in accordance with an embodiment, in step 91 of setting the subject platform, any problem of the hardware found through the diagnostic software may be debugged according to debugging code or the like.

The step 93 of hardware abstraction may be performed through a hardware abstract layer (HAL), which is a software layer that hides hardware through a set of defined programming interfaces.

By way of example but not limitation, the hardware abstraction layer (HAL) may include software or drivers that enable a processor within the controller 130 to communicate with specific peripheral hardware.

The step 95 of loading a bootable image may include forwarding or executing an operating system or an application program included in the user data area to a host or a computing device that is engaged or associated with the memory system. Operating systems or application programs may be of various types, and there may be differences in a way they are executed depending on their type. In addition, the firmware functionality may vary depending on a type of media used to store the boot image. For example, a type that stores an operating system or an application program may be a Flash ROM File System (FFS), a binary image, a Common Object File Format (COFS), or an Executable and Linking Format (ELF).

The step 97 of handing over (or passing) control to a computing device that is engaged with the memory system may be performed by a boot loader included in the firmware. The step of handing over the control (step 97) may include a step of passing control of the recognized platform from the firmware into the operating system or the application program.

The step 99 of transferring map information to the computing device can include the steps of transferring map from the memory system 100 to the host 102 after power-on described with reference to FIG. 1. After the memory system 110 can select map information based on a log or a history stored before power-off, the selected map information may be transferred to a computing device or a host. Operations or processes for the memory system to transfer the map information to the computing device or the host will be described in detail below with reference to FIGS. 9 to 12.

An operation of the memory system to transfer map information to the computing device or the host, during the initial operation after power-up, can be different or distinguishable from another operation of handling or processing a command or an instruction received from the host and then transmitting the map information to the computing device or the host depending on the processing result. The memory system may recognize a usage frequency of data requested by the computing device or the host through processes of processing a plurality of commands or instructions inputted from the computing device or the host. However, because the initial operation after power-on is performed before plural operations in response to a plurality of commands or instructions transmitted from the computing device or the host, it may be difficult to determine which map information the memory system transfer to the computing device or the host. When the memory system transmits map information regarding data, which is not frequently accessed or used by the computing device or host, into the computing device or host, the transmitted map information might be useless, i.e., an effect achieved by sharing the map information between the memory system and the computing device or the host may be low or not good. However, in an embodiment of the present disclosure, the map information selected based on the log or the history stored in the memory system is shared between the memory system and the computing device or the host, thereby improving or enhancing an operation of the data processing system including the memory system and the computing device or the host such as input/output (I/O) throughput of the memory system.

FIG. 9 illustrates a second example of a transaction between a host and a memory system in a data processing system according to an embodiment of the present disclosure.

Referring to FIG. 9, the memory system 110 may transfer map information (MAP INFO) to the host 102. The memory system 110 may use a response RESPONSE regarding the command of the host 102 to transfer the map information (MAP INFO). Herein, the response RESPONSE is a kind of messages or packets which is transmitted after the memory system completely performs an operation in response to a command inputted from the host 102.

In an embodiment, there may be no particular limitation on a response for transmitting map information. For example, the memory system 110 may transmit the map information to the host 102 by using a response corresponding to a read command, a write command, or an erase command.

The memory system 110 and the host 102 may exchange a command or a response with each other in a specific format set according to a predetermined protocol. For example, a format of the response RESPONSE may include a basic header, a result or a state according to success or failure of the command inputted from the host 102, and additional information indicating an operational state of the memory system 110. The memory system 110 may add or insert map information into the format of the response RESPONSE to transmit the map information to the host 102.

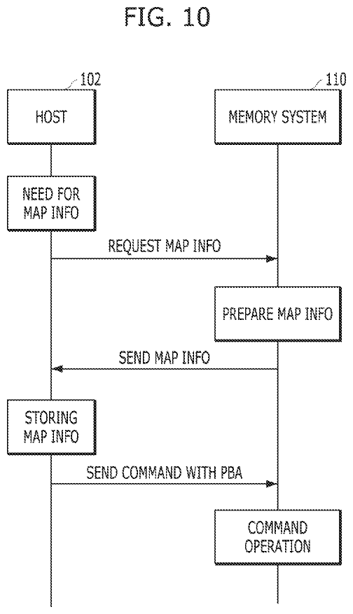

FIG. 10 illustrates a second operation between a host and a memory system according to an embodiment of the present disclosure. Specifically, FIG. 10 illustrates an operation where the host 102 first requests map information to the memory system 110 and then the memory system 110 transmits map information in response to a request of the host 102.

Referring to FIG. 10, a need for map information may occur at the host 102. For example, if the host 102 can allocate a space to store map information, or if the host 102 expects faster data input/output (I/O) of the memory system 110 in response to the host's command, the host 102 can request the map information to the memory system 110. In addition, a need for the map information may also be generated in the host 102 at a user's request.

The host 102 may request map information to the memory system 110, and the memory system 110 may prepare the map information in response to the request from the host 102. In an embodiment, the host 102 may request specific map information such as a specific range of map information from the memory system 110. In another embodiment, the host 102 may generally request map information from the memory system 110, and the memory system 110 may determine which map information is provided to the host 102.

After the memory system 110 transfers prepared map information to the host 102, the host 102 may store the transferred map information in an internal storage space, e.g., the memory 106 described with reference to FIG. 4.

Using the stored map information, the host 102 may add the physical address PBA in a format of a command COMMAND transmitted to the memory system 110 and transmit the format of the command COMMAND including the physical address PBA. Then, the memory system 110 may use the physical address PBA inputted with the command COMMAND from the host 102 to perform an operation corresponding to the command COMMAND.

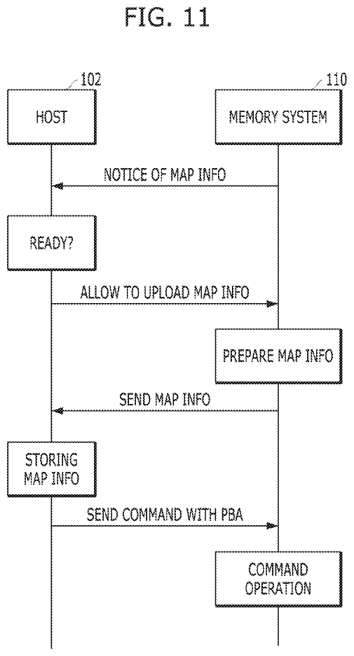

FIG. 11 illustrates a third operation between a host and a memory system according to an embodiment of the present disclosure. Specifically, FIG. 11 illustrates an operation where the memory system 110 inquires the host 102 for transmitting map information, the host 102 determines whether to allow transmission from the memory system 110, and the host 102 receives the map information in response to the inquiry of the memory system 110.

Referring to FIG. 11, the memory system 110 may notify the host 102 of transmitting map information. The host 102 can determine whether the host 102 can store the map information associated with the notification regarding transmission of the map information, which is delivered from the memory system 110. If the host 102 can receive and store the map information inputted from the memory system 110, the host 102 can allow the memory system 100 to transfer the map information. According to an embodiment, the memory system 110 may prepare map information to be transmitted, and then transmit the prepared map information to the host 102.

The host 102 may store the received map information in an internal storage space (e.g., the memory 106 described with reference to FIG. 4). The host 102 may include a physical address PBA in a command to be transmitted to the memory system 110 after performing a mapping operation based on the stored map information.

The memory system 110 may check whether the physical address PBA is included in the command transmitted from the host 102, and apply the physical address PBA to perform an operation corresponding to the command.

Regarding the transmission of the map information, the host 102 can initiatively perform the operation between the host 102 and the memory system 110 described with reference to FIG. 10. But, the memory system 110 can initiatively perform the operation between the host 102 and the memory system 110 described with reference to FIG. 11. According to different embodiments, the memory system 110 can perform the transmission of the map information differently. According to an operational condition or environment, the memory system 102 and the host 110 may selectively use a method for transmitting map information described with reference to FIGS. 10 and 11.

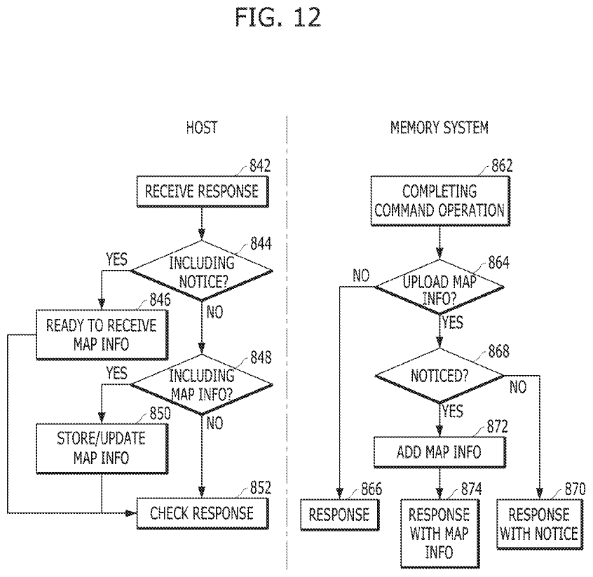

FIG. 12 illustrates a fourth operation between a host and a memory system according to an embodiment of the present disclosure. In detail, FIG. 12 illustrates a case where the memory system attempts to transmit map information to the host while the host and the memory system are operatively engaged with each other.

Referring to FIG. 12, the memory system may determine whether an operation corresponding to a command transmitted from a host is completed (step 862). After the operation corresponding to the command is completed, the memory system may check whether there is map information to be transmitted to the host before transmitting a response corresponding to the command (step 864). If there is no map information to be transmitted to the host (NO in step 864), the memory system may transmit a response RESPONSE including information (e.g., success or failure) regarding whether the operation corresponding to the command sent from the host has completed (step 866).

When the memory system recognizes map information to be transmitted to the host (YES of step 864), the memory system may check whether a notice NOTICE for transmitting the map information has been made (step 868). The notification may be similar to that described with reference to FIG. 11. When the memory system is to send the map information but the notification regarding the memory system sending the map information to the host has not been made in advance (NO of step 868), the memory system can add the notice NOTICE to the response RESPONSE. In addition, the memory system may transmit the response RESPONSE with the notice NOTICE to the host (step 870).

When the notice NOTICE for inquiring transmission of the map information has already been made (YES of step 868), the memory system may add the map information to the response (step 872). Thereafter, the memory system may transmit a response including the map information (step 874). According to an embodiment, the host can send permission for transmitting the map information to the memory system before the memory system transmits the map information to the host.

The host may receive at least one of the response.

RESPONSE, the response including the notice (RESPONSE WITH NOTICE), or the response including the map information (RESPOSNE WITH MAP INFO.), which are transmitted by the memory system and received by the host (step 842).

The host may verify whether the received response includes the notice (step 844). If the received response includes the notice (YES of step 844), the host can prepare to receive and store map information that can be delivered later (step 846). Thereafter, the host may check the response corresponding to a command previously transmitted to the memory system (step 852). For example, the host can check the response to confirm whether an operation corresponding to a command previously sent has succeeded or failed in the memory system.

When the received response does not include the notice (NO of step 844), the host may determine whether the response includes map information (step 848). When the response does not include map information (NO of step 848), the host may check the response corresponding to the command previously transmitted to the memory system (step 852).

When the received response includes map information (YES at step 848), the host may store the map information included in the response within a storage space or update the map information already stored in the storage space (step 850). Then, the host may check the response corresponding to the command previously transmitted to the memory system (step 852).

Based on embodiments described above, the memory system may transmit the map information to the host. After processing the command transmitted by the host, the memory system may utilize a response associated with the transmitted command in order to transmit the map information. In addition, the memory system may transmit the map information to the host, and then generate and store a log or a history regarding the transmitted map information. Even if power is resumed after power is interrupted to the host and the memory system, the memory system may transmit map information to the host using the log or the history described above. The host may transmit a command with logical and physical addresses to the memory system after performing a mapping operation or an address translation based on the transmitted map information. Through the command with the logical and physical addresses, data input/output (I/O) performance of the memory system may be improved or enhanced.

According to embodiments of the present disclosure, a data processing system, a method for operating the data processing system and a method of controlling an the operation in the data processing system can provide a memory system which is capable of transmitting map information to a host in a short time after power is resumed. Accordingly, even though the host lost map information due to sudden power off (SPO) or the like, the memory system can transmit the map information and the host can recover the map information. The host can use the recovered map information and send a command along with map information to the memory system, and the memory system can omit an operation for address translation to increase input/output (I/O) throughput.

In an embodiment of the present disclosure, a memory system can store a record, a log, or a history of map information shared with a host or a computing device before powering off. The memory system can sort and transmit map information to share the map information based on the record, the log, or the history when power is resumed, thereby improving operational efficiency of the memory system.

In addition, according to an embodiment of the present disclosure, when a usage pattern of a user who uses a data processing system including a memory system and a host or a computing device is not changed significantly or dramatically before power-off and after power-on, the operational efficiency of the data processing system can be improved because shared map information can be selected and transmitted based on the usage pattern.

While the present teachings have been illustrated and described with respect to specific embodiments, it will be apparent to those skilled in the art in light of the present disclosure that various changes and modifications may be made without departing from the spirit and scope of the disclosure as defined in the following claims.

What is claimed is:

1. A memory system, comprising:
a memory device including nonvolatile memory cells; and
a controller configured to generate map information used for translating a logical address inputted from a host into a physical address indicating a location of data stored in the memory device,
wherein the controller is configured to:
transmit at least some of the map information to the host;
store a log regarding the at least some of the map information transmitted to the host; and
again transmit the at least some of the map information to the host based on the log during an initial operation.

2. The memory system according to claim 1, wherein the controller is configured to transmit the at least some of the map information in response to a request received from the host.

3. The memory system according to claim 1, wherein the controller is configured to send an inquiry for transmitting the at least some of the map information to the host and configured to transmit the at least some of the map information based on a determination regarding the inquiry made by the host.

4. The memory system according to claim 1, wherein the controller is configured to:
perform an operation corresponding to a command inputted from the host;
insert the at least some of the map information into a response regarding the command; and
transfer the response including the inserted at least some of the map information to the host.

5. The memory system according to claim 1, wherein the controller is configured to:
determine that a command inputted from the host includes a logical address and a physical address;
determine whether the physical address inputted with the command is valid;
determine whether the physical address is used based on the validity of the physical address; and
perform an operation corresponding to the command using the physical address.

6. The memory system according to claim 5, wherein the controller is configured to ignore the physical address when the physical address is not valid and to search for a valid physical address corresponding to the logical address from the map information stored in the memory device before performing the command.

7. The memory system according to claim 1, wherein the controller is configured to determine an amount of the map information which is included in the log based on a size of the map information capable of being transmitted to the host.

8. The memory system according to claim 1, wherein, during the initial operation, the controller is configured to execute firmware, load a boot image, abandon and hand over control authority to the host, and transfer the at least some of the map information after handing over the control authority to the host.

9. The memory system according to claim 1, wherein the log is stored before the memory system is powered off, and the initial operation is performed directly after power to the memory system is restored.

10. A method for operating a memory system, comprising:
generating map information used for translating a logical address inputted from a host into a physical address indicating a location of data stored in a memory device of the memory system;
transmitting at least some of the map information to the host;
storing a log regarding the at least some of the map information; and
again transmitting the at least some of the map information to the host based on the log or the history during an initial operation.

11. The method according to claim 10, further comprising receiving from the host a command regarding the at least some of the map information before transmitting the at least some of the map information to the host.

12. The method according to claim 10, further comprising sending an inquiry for transmitting the at least some of the map information to the host,
wherein the at least some of the map information is transmitted to the host based on a determination regarding the inquiry made by the host.

13. The method according to claim 10, further comprising:
performing an operation corresponding to a command inputted from the host; and
inserting the at least some of the map information into a response regarding the command,
wherein the inserted at least some of the map information is transmitted to the host through the response.

14. The method according to claim 10, further comprising:
determining that a command inputted from the host includes a logical address and a physical address;
determining whether the physical address inputted with the command is valid;
determining usage of the physical address based on the validity of the physical address; and
perform an operation corresponding to the command using the physical address.

15. The method according to claim 14, further comprising:
ignoring the physical address when the physical address is determined to be not valid; and
searching for a valid physical address corresponding to the logical address from the map information stored in the memory device before performing the command.

16. The method according to claim 10, further comprising:
determining an amount of the map information which is included in the log based on a size of the map information capable of being transmitted to the host.

17. The method according to claim 10, further comprising:
during the initial operation, executing a firmware;
loading a boot image; and
abandoning and handing over control authority to the host,
wherein the at least some of the map information is transferred after the control authority is handled over.

18. A data processing system, comprising:
a host configured to at least one of generate, change, or update logical addresses corresponding to plural pieces of data; and
a memory system configured to:
store the plural pieces of data at locations identified through physical addresses which are distinguishable from the logical addresses;
transmit to the host at least some map information used for translating the logical addresses into the physical addresses;
store a log regarding the at least some map information; and
again transmit to the host the at least some map information based on the log during an initial operation.

19. The data processing system according to claim 18, wherein the memory system is configured to:
determine that a command inputted from the host includes a logical address and a physical address;
determine whether the physical address included with the command is valid;
determine whether the physical address is used based on the validity of the physical address; and
perform an operation corresponding to the command using the physical address.

20. The data processing system according to claim 18, wherein the memory system is configured to determine an amount of the map information which is included in the log based on a size of the map information capable of being transmitted to the host.
